(19) United States
(12) Patent Application Publication
(10) Pub. No.: US 2011/0066830 A1
(43) Pub. Date: Mar. 17, 2011

(54) CACHE PREFILL ON THREAD MIGRATION

(76) Inventors: Andrew Wolfe, Los Gatos, CA (US); Thomas M. Conte, Atlanta, GA (US)

(21) Appl. No.: 12/557,864

(22) Filed: Sep. 11, 2009

(51) Int. Cl. G06F 9/315; G06F 12/08

(52) U.S. Cl. 712/228; 711/125; 711/E12.017; 712/E09.034

(57) ABSTRACT

Techniques for pre-filling a cache associated with a second core prior to migration of a thread from a first core to the second core are generally disclosed. The present disclosure contemplates that some computer systems may include a plurality of processor cores, and that some cores may have hardware capabilities different from other cores. In order to assign threads to appropriate cores, thread/core mapping may be utilized and, in some cases, a thread may be reassigned from one core to another core. In a probabilistic anticipation that a thread may be migrated from a first core to a second core, a cache associated with the second core may be pre-filled (e.g., may become filled with some data before the thread is rescheduled on the second core). Such a cache may be a local cache to the second core and/or an associated buffer cache, for example.

### CROSS REFERENCE TO RELATED APPLICATIONS

This application may be related to co-pending U.S. patent application Ser. No. 12/427,602, entitled “THREAD MAPPING IN MULTI-CORE PROCESSORS,” filed Apr. 21, 2009, by Wolfe et al., U.S. patent application Ser. No. ______, entitled “THREAD SHIFT: ALLOCATING THREADS TO CORES,” filed ______, 2009, by Wolfe et al., and/or co-pending U.S. patent application Ser. No. ______, entitled “MAPPING OF COMPUTER THREADS ONTO HETEROGENEOUS RESOURCES,” filed ______, 2009, by Wolfe et al., the entire disclosures of which are incorporated herein by reference.

### BACKGROUND

The present disclosure is related to multi-core computer systems and, more particularly, to transferring data in anticipation of thread migration between cores.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a block diagram illustrating an example multi-core system;

FIG. 2 is block diagram illustrating an example multi-core system including a performance counter;

FIG. 3 is a flowchart depicting an example method for migrating a thread from a first processor core to a second processor core;

FIG. 4 is a schematic diagram illustrating an example article including a storage medium comprising machine-readable instructions;

FIG. 5 is a flowchart depicting an example method for prefilling a cache; and

FIG. 6 is a block diagram illustrating an example computing device that may be arranged for cache prefill implementations; all configured in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

This disclosure is drawn, inter alia, to methods, systems, devices, and/or apparatus generally related to multi-core computers and, more particularly, to transferring data in anticipation of thread migration between cores.

The present disclosure contemplates that some computer systems may include a plurality of processor cores. In a multi-core system with heterogeneous hardware, some cores may have certain hardware capabilities not available to other cores. An example core may be associated with a cache, which may include a temporary storage area where frequently accessed data may be stored for rapid access. Such a cache may be a local cache and/or an associated buffer cache, for example. In some example computer systems, at least one thread (which may be a sequence of instructions and which may execute in parallel with other threads) may be assigned to an appropriate core. Thread/core mapping may be utilized to associate threads with appropriate cores. In some example computer systems, a thread may be reassigned from one core to another core before execution of the thread is complete.

The present disclosure describes that when a thread is rescheduled from a first core to a second core, a cache associated with the second core may be pre-filled. In other words, the cache associated with the second core may be at least partially filled with thread-related data before the thread is rescheduled on the second core.

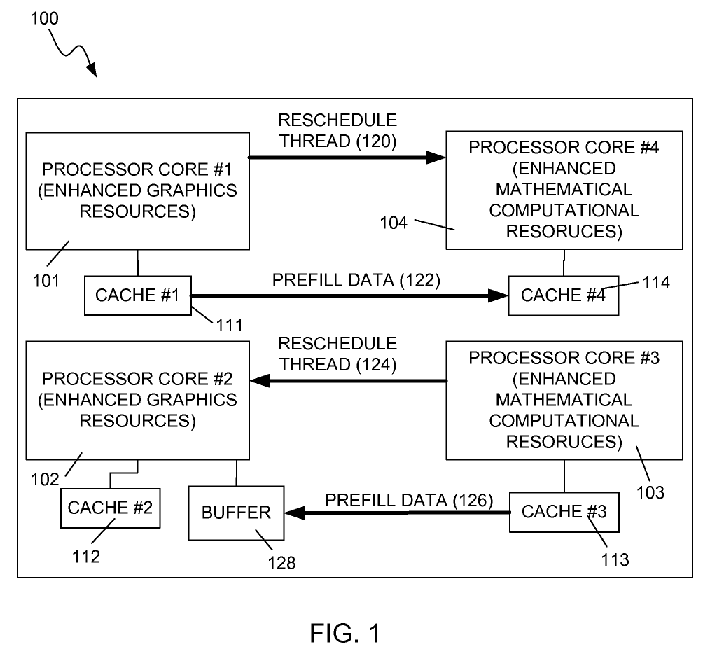

FIG. 1 is a block diagram illustrating an example multi-core system 100 arranged in accordance with at least some embodiments of the present disclosure. An example multi-core system 100 may include a plurality of processor cores 101, 102, 103, and/or 104. Individual cores 101, 102, 103, and/or 104 may be associated with one or more caches 111, 112, 113, and/or 114, and/or buffers 128. In an example embodiment, a multi-core system 100 may include one or more cores 101, 102, 103, and/or 104, each core having different capabilities. In other words, a multi-core system 100 may include heterogeneous hardware. For example, cores 101 and 102 may include enhanced graphics resources and/or cores 103 and 104 may include enhanced mathematical computational resources.

In an example embodiment, a thread 120 which may initially benefit from enhanced graphics capabilities may be initially executed on core 101. Based at least in part on the expectation that thread 120 may benefit from enhanced mathematical computational capabilities, data 122 pertaining to thread 120 may be prefilled into cache 114, and thread 120 may be rescheduled to core 104 to complete its execution. Similarly, a thread 124 which may initially benefit from enhanced mathematical computational capabilities may be initially executed on core 103. Based at least in part on the expectation that thread 124 may benefit from enhanced graphics capabilities, data 126 pertaining to thread 124 may be prefilled into buffer 128, and thread 124 may be rescheduled to core 102. In this example embodiment, one or more of data 122 and 126 may be filled into cache 114 and/or buffer 128, respectively, prior to rescheduling threads 120 and 124 to cores 104 and 102, respectively.

In some example embodiments, cores may include different instruction sets; different accelerators (e.g., DSPs (digital signal processors) and/or different SSEs (streaming SIMD (single instruction, multiple data) extensions)); larger and/or smaller caches (such as L1 and L2 caches); different branch predictors (the parts of a processor that determine whether a conditional branch in the instruction flow of a program is likely to be taken or not); and/or the like. Based at least in part on these and/or other differences between cores, different cores may provide different capabilities for certain tasks.

In some example embodiments, some threads may be associated with one or more execution characteristics, which may be expressed and/or based on information collected by one or more performance counters, for example. In some example embodiments, thread mapping may be based at least in part on one or more of the execution characteristics.

In some example embodiments, threads may be mapped to individual cores based at least in part on the hardware capabilities of the cores. For example, a thread associated with a large L1 cache (memory) demand may be mapped to a core including large L1 cache hardware. Similarly, a thread associated with a large SSE (instruction set) demand may be mapped to a core including native SSE hardware implementation. These examples are non-limiting, and it will be understood that threads may be mapped based at least in part on any hardware characteristic, instruction set, and/or other characteristic of a core and/or a thread.

In some example embodiments, thread execution characteristics may vary over time based on a phase of the program running in the thread. For example, a thread may originally have a large L1 cache demand, but may have a minimal L1 cache demand at a later time. The thread may be mapped to different cores at different times during its execution, which may result in improved performance. For example, the thread may be mapped to a core including a relative large L1 cache when L1 demand is high, and/or the thread may be mapped to a core having a smaller L1 cache when L1 demand is lower.

In some example embodiments, determining whether or not to migrate a thread to a different core and/or when to perform such a migration may include evaluating of at least a portion of an execution profile that may include data related to a prior execution of the thread. In some example embodiments, the execution profile may be generated using a freeze-dried ghost page execution profile generation method as disclosed in U.S. Patent Application Publication No. 2007/0050605, which is incorporated by reference. This method may use a shadow processor, or in some embodiments a shadow core, to simulate the execution of at least a portion of a thread in advance and to generate performance statistics and measurements related to this execution.

In some example embodiments, a thread scheduler within the operating system may establish probabilities for thread migration. For example, the scheduler may examine the pending thread queue to determine how many threads are waiting to be scheduled and how many of those threads would prefer to be scheduled on core 2. The scheduler may also estimate how long a current portion of the current thread executing on core 1 (thread A) will require in order to complete. An estimation may then be performed to determine the likelihood that one of the waiting threads will be scheduled on core 2 prior to thread A requesting rescheduling. If this probability estimate exceeds a predetermined threshold, then data related to thread A may be migrated to the core 2 cache.

In some example embodiments, processors and/or caches may be adapted to collect information as a program executes. For example, such information may include which cache lines the program references. In some example embodiments, data about cache usage may be evaluated to determine which threads should be replaced (e.g., by counting the number of lines of thread process remaining). In an example embodiment, a performance counter may be configured to track line evictions of running threads and/or may use that information to decide which tasks may be flushed out to begin a higher priority task. A performance counter may also be configured to track the line evictions since a task has started. Performance counter data may be incorporated into the estimates of rescheduling probabilities discussed above.

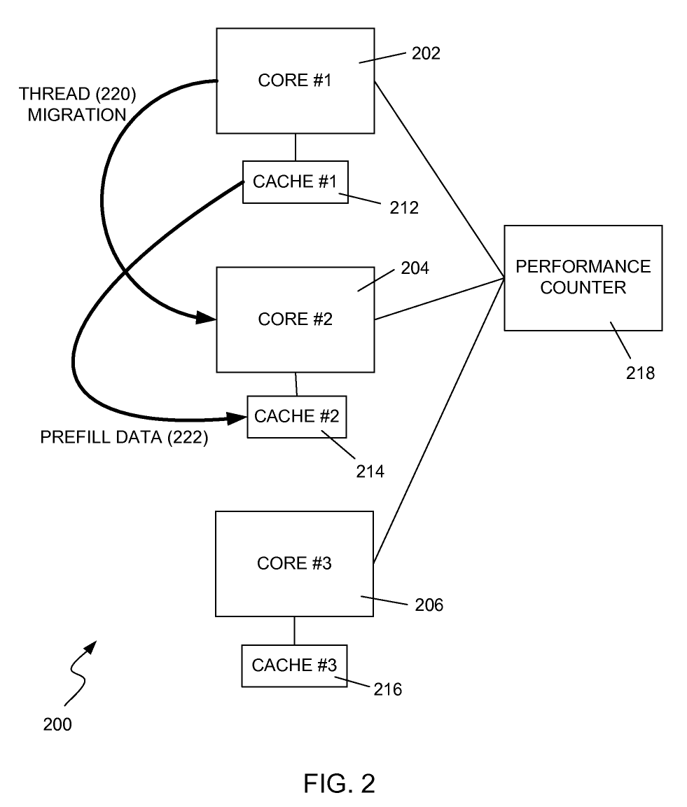

FIG. 2 is block diagram illustrating an example multi-core system 200 including a performance counter 218, arranged in accordance with at least some embodiments of the present disclosure. Cores 202, 204, and/or 206 (which may be associated with caches 212, 214, and/or 216) may be operatively coupled to a performance counter 218. Performance counter 218 may be configured to store the counts for hardware-related activities within the computer system, for example. Thread 220 migration (from core 202 to core 204, for example) may be at least partially determined using data collected by performance counter 218. In some example embodiments, data 222 may be prefilled into cache 214 from cache 212 prior to migration of thread 220.

Some example embodiments may consider the size of a cache footprint for a particular task. In some example embodiments, Bloom filters may be used to characterize how big the cache footprint is for a thread. An example Bloom filter may be a space-efficient probabilistic data structure that may be used to test whether an element is a member of a set. When using some example Bloom filters, false positives are possible, but false negatives are not. In some example Bloom filters, elements may be added to the set, but may not be removed (though this can be addressed with a counting filter). In some example Bloom filters, the more elements that are added to the set, the larger the probability of false positives. An empty Bloom filter may be a bit array of m bits, all set to 0. In addition, k different hash functions may be defined, each of which may map or hash some set element to one of the m array positions with a uniform random distribution. To add an element, the element may be fed to each of the k hash functions to get k array positions. The bits at these positions may be set to 1. To query for an element (e.g., to test whether it is in the set), the element may be fed to each of the k hash functions to get k array positions. In some example Bloom filters, if the bit at any of these positions is 0, then the element is not in the set; if the element was in the set, then all of the bits at the k array positions would have been set to 1 when it was inserted. In some example Bloom filters, if all of the bits at the k array positions are 1, then either the element is in the set, or the bits were set to 1 during the insertion of other elements.

In some example embodiments, a Bloom filter may be used to track which portions of the cache are being used by the current thread. For example, the filter may be emptied when the thread is first scheduled onto the core. Each time a cache line is used by the thread, it may be added to the filter set. A sequence of queries may be used to estimate the thread footprint in order to evaluate the cost of cache data migration. In some example embodiments, a simple population count of the number of “1” bits in the filter may be used to estimate the cache footprint of the thread. In some example embodiments, counting Bloom filters may be used. In a counting Bloom filter, each filter element may be a counter which may be incremented when a cache line is used by the thread and may be decremented when the cache line is invalidated.

In some example embodiments, data associated with threads may be evaluated to determine when a thread should be migrated to another core and/or to which core the thread should be migrated. For example, a system may use real-time computing (RTC) data relating to a thread to determine whether the thread is falling behind a target deadline. If the thread is falling behind the target deadline, the thread may be migrated to a faster core (e.g., a core operating at a higher clock speed), for example.

In some example embodiments, the cache data for a thread migration may be pre-fetched The prefetching may be performed by a hardware prefetcher as is known in the art. One such prefetcher is disclosed in U.S. Pat. No. 7,318,125, which is incorporated by reference. That is, when the system is preparing to migrate a thread to a new core, references from the current core may be sent to the new core to prepare for the migration. Thus, the new core may be “warmed up” in preparation for the migration. In some embodiments, substantially all of the data relating to the thread to be migrated may be pre-fetched by the new core. In some other example embodiments, a portion of the data relating to the thread to be migrated may be pre-fetched by the new core. For example, the cache misses, hits, and/or line evictions may be pre-fetched. In some example embodiments, rather than caching the data in the new core (and thereby filling up the new core with data that may ultimately not be required), the data may be pre-fetched to a side/stream buffer, for example.

As used herein, “cache hit” may refer to a successful attempt to reference data that has been cached, as well as the corresponding data. As used herein, “cache miss” may refer to an attempt to reference data that has not been found in the cache, as well as the corresponding data. As used herein, “line eviction” may refer to removing a cached line from the cache, such as to make space for different data in the cache. Line eviction may also include a write-back operation whereby modified data in the cache is written to main memory or a higher cache level prior to being removed from the cache.

Thread migration may be expected and/or anticipated based at least partially on, for example, variation of thread execution characteristics over time, data associated with a performance counter, and/or data associated with threads (e.g., RTC computing data).

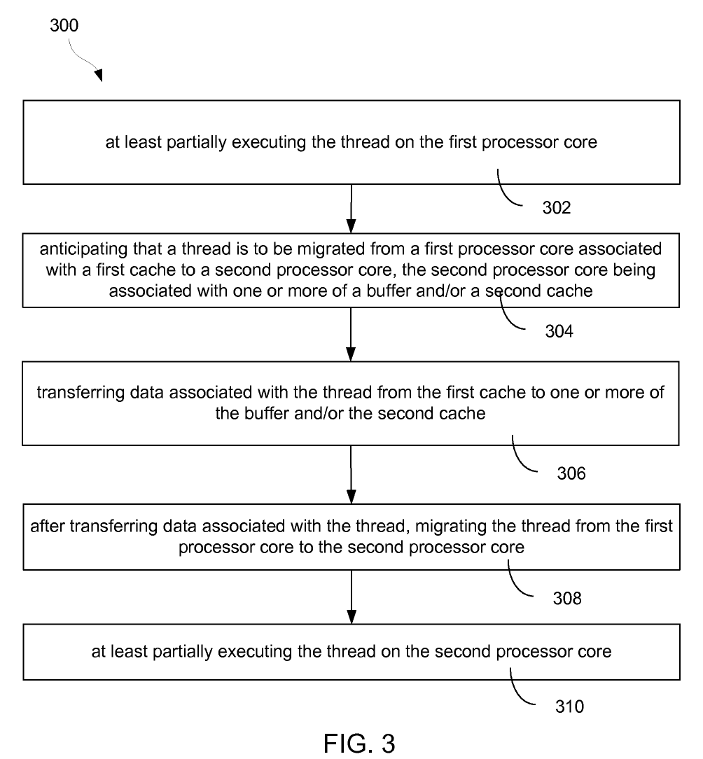

FIG. 3 is a flowchart depicting an example method 300 for migrating a thread from a first processor core to a second processor core, arranged in accordance with at least some embodiments of the present disclosure. Example methods 300 may include one or more of processing operations 302, 304, 306, 308 and/or 310.

Processing may begin at operation 304, which may include anticipating that the thread is to be migrated from a first processor core associated with a first cache to a second processor core, the second processor core being associated with one or more of a buffer and/or a second cache. Operation 304 may be followed by operation 306, which may include transferring data associated with the thread from the first cache to one or more of the buffer and/or the second cache. Operation 306 may be followed by operation 308, which may include migrating the thread from the first processor core to the second processor core.

Some example methods may include operation 302 prior to operation 304. Operation 302 may include at least partially executing the thread on the first processor core. Some example methods may include operation 310 after operation 308. Operation 310 may include at least partially executing the thread on the second processor core.

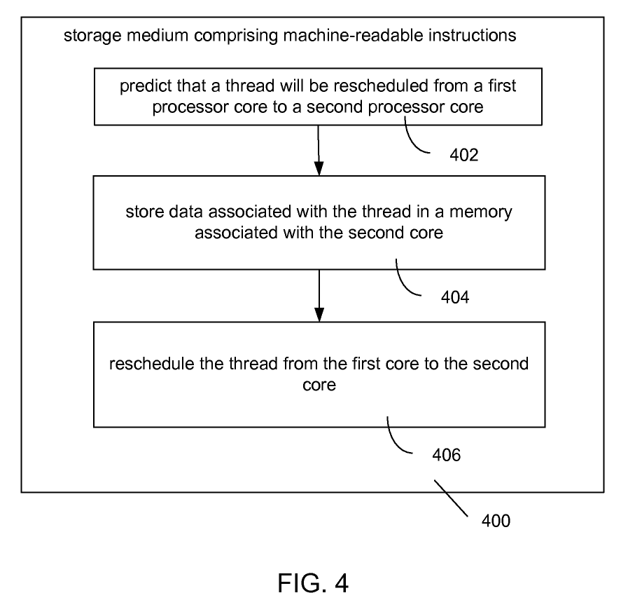

FIG. 4 is a schematic diagram illustrating an example article including a storage medium 400 comprising machine-readable instructions, arranged in accordance with at least some embodiments of the present disclosure. When executed by one or more processing units, the machine readable instructions may operatively enable a computing platform to predict that a thread will be rescheduled from a first processor core to a second processor core (operation 402); store data associated with the thread in a memory associated with the second core (operation 404); and reschedule the thread from the first core to the second core (operation 406).

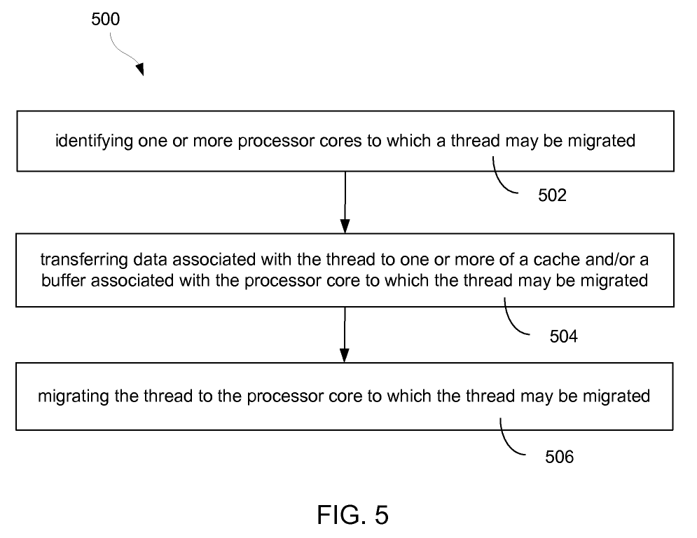

FIG. 5 is a flowchart depicting an example method 500 for prefilling a cache in accordance with at least some embodiments of the present disclosure. Example methods 500 may include one or more of processing operations 502, 504, and/or 506.

Processing for method 500 may begin at operation 502, which may include identifying one or more processor cores to which a thread may be migrated. Operation 502 may be followed by operation 504, which may include transferring data associated with the thread to one or more of a cache and/or a buffer associated with the processor core to which the thread may be migrated. Operation 504 may be followed by operation 506, which may include migrating the thread to the processor core to which the thread may be migrated.

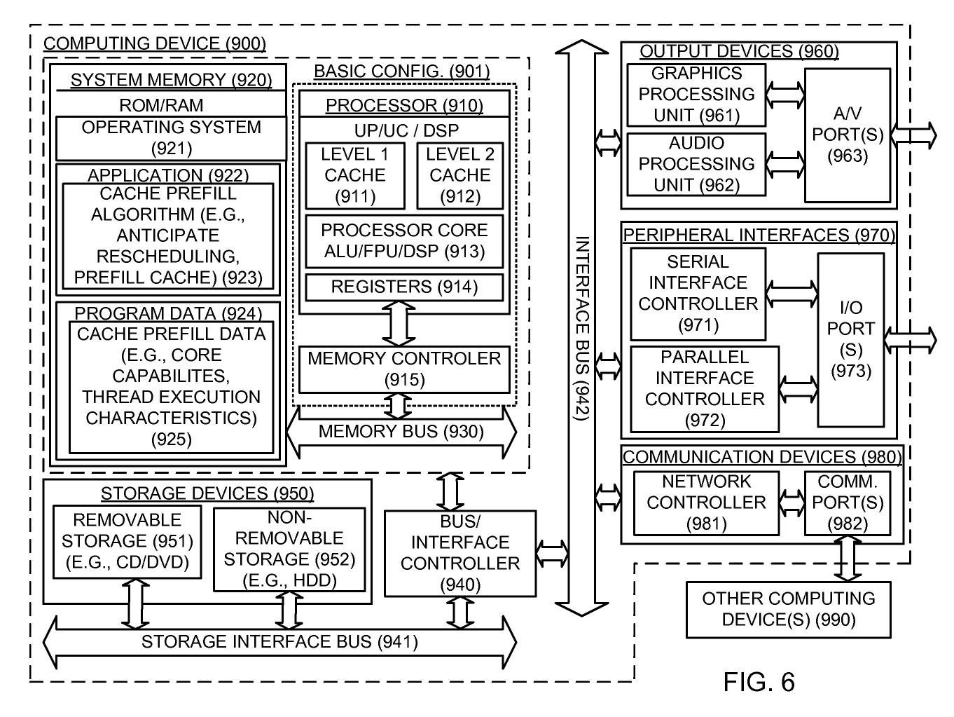

FIG. 6 is a block diagram illustrating an example computing device 900 that is arranged for cache prefill in accordance with at least some embodiments of the present disclosure. In a very basic configuration 901, computing device 900 typically may include one or more processors 910 and system memory 920. A memory bus 930 can be used for communicating between the processor 910 and the system memory 920.

Depending on the desired configuration, processor 910 can be of any type including but not limited to a microprocessor (μP), a microcontroller (μC), a digital signal processor (DSP), or any combination thereof. Processor 910 can include one more levels of caching, such as a level one cache 911 and a level two cache 912, a processor core 913, and registers 914. The processor core 913 can include an arithmetic logic unit (ALU), a floating point unit (FPU), a digital signal processing core (DSP Core), or any combination thereof. A memory controller 915 can also be used with the processor 910, or in some implementations the memory controller 915 can be an internal part of the processor 910.

Depending on the desired configuration, the system memory 920 can be of any type including but not limited to volatile memory (such as RAM), non-volatile memory (such as ROM, flash memory, etc.) or any combination thereof. System memory 920 typically includes an operating system 921, one or more applications 922, and program data 924. Application 922 may include a cache prefill algorithm 923 that may be arranged to anticipate rescheduling and prefill a cache. Program Data 924 may include cache prefill data 925 that may be useful for prefilling a cache, as will be further described below. In some embodiments, application 922 can be arranged to operate with program data 924 on an operating system 921 such that a cache may be prefilled in accordance with the techniques described herein. This described basic configuration is illustrated in FIG. 6 by those components within dashed line 901.

Computing device 900 can have additional features or functionality, and additional interfaces to facilitate communications between the basic configuration 901 and any required devices and interfaces. For example, a bus/interface controller 940 can be used to facilitate communications between the basic configuration 901 and one or more data storage devices 950 via a storage interface bus 941. The data storage devices 950 can be removable storage devices 951, non-removable storage devices 952, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 920, removable storage 951 and non-removable storage 952 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media can be part of device 900.

Computing device 900 can also include an interface bus 942 for facilitating communication from various interface devices (e.g., output interfaces, peripheral interfaces, and communication interfaces) to the basic configuration 901 via the bus/interface controller 940. Example output devices 960 include a graphics processing unit 961 and an audio processing unit 962, which can be configured to communicate to various external devices such as a display or speakers via one or more A/V ports 963. Example peripheral interfaces 970 include a serial interface controller 971 or a parallel interface controller 972, which can be configured to communicate with external devices such as input devices (e.g., keyboard, mouse, pen, voice input device, touch input device, etc.) or other peripheral devices (e.g., printer, scanner, etc.) via one or more I/O ports 973. An example communication device 980 includes a network controller 981, which can be arranged to facilitate communications with one or more other computing devices 990 over a network communication via one or more communication ports 982. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 900 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 900 can also be implemented as a personal computer including both laptop computer and non-laptop computer configurations.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of migrating a thread from a first processor core to a second processor core, the method comprising:
anticipating that a thread is to be migrated from a first processor core associated with a first cache to a second processor core, the second processor core being associated with one or more of a buffer and/or a second cache;
transferring at least a portion of data associated with the thread from the first cache to one or more of the buffer and/or the second cache; and
after transferring at least the portion of data associated with the thread, migrating the thread from the first processor core to the second processor core;
wherein the one or more of the buffer and/or the second cache is at least partially filled with at least the portion of data associated with the thread before migrating the thread from the first processor core to the second processor core.

2. The method of claim 1, further comprising, prior to anticipating that the thread is to be migrated, at least partially executing the thread on the first processor core.

3. The method of claim 1, further comprising, after migrating the thread, at least partially executing the thread on the second processor core.

4. The method of claim 1, wherein the data includes one or more of a cache miss, a cache hit, and/or a cache line eviction associated with the thread.

5. The method of claim 1, wherein the second processor core is associated with the second cache; and wherein transferring the data includes transferring the data from the first cache to the second cache.

6. The method of claim 5, wherein the second cache includes existing data associated with the thread; and wherein transferring the data includes transferring new data associated with the thread.

7. The method of claim 6, wherein the new data includes one or more of a cache miss, a cache hit, and/or a cache line eviction associated with the thread.

8. The method of claim 1, wherein the second processor core is associated with the buffer; and wherein transferring the data includes transferring the data from the first cache to the buffer.

9. The method of claim 1, wherein anticipating that the thread is to be migrated to the second processor core comprises determining that there is at least a threshold probability that the thread is to be migrated to the second processor core.

10. The method of claim 1, wherein anticipating that the thread is to be migrated to a second processor core is based at least in part on one or more of hardware capabilities of the second processor core.

11. An article comprising:
a storage medium comprising machine-readable instructions stored thereon, which, when executed by one or more processing units, operatively enable a computing platform to:
predict that a thread will be rescheduled from a first processor core to a second processor core;
store data associated with the thread in a memory associated with the second core in response to predicting that the thread will be rescheduled from the first processor core to the second processor core; and
reschedule the thread from the first core to the second core after the data associated with the thread is stored in the memory associated with the second core.

12. The article of claim 11, wherein the data associated with the thread is new data associated with the thread; and wherein the memory includes existing data associated with the thread.

13. The article of claim 11, wherein the instructions enable the computing platform to predict that the thread will be rescheduled based at least in part upon a probability that the thread will be rescheduled.

14. The article of claim 11, wherein one or more hardware capabilities associated with the first processor core differ from one or more hardware capabilities associated with the second processor core; and wherein the instructions enable the computing platform to predict that the thread will be rescheduled based at least in part upon the one or more hardware capabilities associated with the first processor core, the one or more hardware capabilities associated with the second processor core, and one or more execution characteristics associated with the thread.

15. The article of claim 11, wherein the memory includes one or more of a cache and/or a buffer.

16. The article of claim 11, wherein the instructions enable the computing platform to reschedule the thread from the first core to the second core subsequent to storage of substantially all of the data associated with the thread in the memory associated with the second core.

17. A method of prefilling a cache comprising:
identifying one or more processor cores to which a thread is to be migrated;
transferring data associated with the thread to one or more of a cache and/or a buffer associated with the processor cores to which the thread is to be migrated; and
migrating the thread to the processor cores to which the thread is to be migrated after transferring at least a portion of the data to the one or more of the cache and/or the buffer associated with the processor cores to which the thread is to be migrated.

18. The method of claim 17, wherein transferring the data is substantially complete prior to migrating the thread.

19. The method of claim 17, wherein identifying the processor core to which the thread may be migrated is based at least in part on information collected using a performance counter associated with at least one of the processor cores.

20. The method of claim 19, wherein the information collected using the performance counter includes numbers of line evictions associated with individual threads running on the processor cores.

21. The method of claim 17, wherein identifying the processor core to which the thread may be migrated is based at least in part on real-time computing information associated with the thread; and wherein, when the real-time computing information indicates that the thread is falling behind a target deadline, the thread is migrated to a faster one of the processor cores.

22. The method of claim 17, wherein transferring the data associated with the thread includes transferring the data from a first cache associated with a current processor core to a second cache associated with the processor core to which the thread may be migrated.

23. A multi-core system comprising:
a first processor core;
a first cache associated with the first processor core;
a second processor core; and
one or more of a second cache and/or a buffer associated with the second processor core;
wherein the multi-core system is configured to transfer data from the first cache to one or more of the second cache and/or the buffer before migrating a thread from the first processor core to the second processor core and, subsequently, migrating the thread from the first processor core to the second processor core, the thread being associated with the data.

24. The multi-core system of claim 23, wherein the first processor core has a first capability and the second processor core has a second capability that is different from the first capability such that the multi-core system comprises heterogeneous hardware.

25. The multi-core system of claim 24, wherein each of the first capability and the second capability corresponds to at least one of: a graphics resource, a mathematical computational resource, an instruction set, an accelerator, an SSE, a cache size and/or a branch predictor.

26. The multi-core system of claim 23, wherein the data comprises one or more of a cache miss, a cache hit, and/or a cache line eviction associated with the thread.
